(19) United States
(12) Patent Application Publication
(10) Pub. No.: US 2026/0158439 A1
(43) Pub. Date: Jun. 11, 2026

(54) DIRECT AIR CAPTURE SYSTEM AND PROCESS HAVING HEATING SYSTEM FOR PARTIAL DESORPTION OF WATER

(71) Applicant: Mosaic Materials, Inc., Alameda, CA (US)

(72) Inventors: Steven Craig Russell, The Woodlands, TX (US); Paul Cody, Houston, TX (US); Tiffany Burgess, Magnolia, TX (US); Graham Wenz, Richmond, CA (US); Ignacio Luz, Alameda, CA (US)

(21) Appl. No.: 18/975,709

(22) Filed: Dec. 10, 2024

(51) Int. Cl. B01D 53/26; B01D 53/04

(52) U.S. Cl. CPC B01D 53/261; B01D 53/0454; B01D 53/0462; B01D 2257/504; B01D 2257/80

(57) ABSTRACT

A direct air capture process includes arranging sorbent to adsorb carbon dioxide and water from gas flow, the sorbent having a first temperature, and employing a heating system and heating the sorbent to a second temperature greater than the first temperature. Employing the heating system and heating the sorbent to the second temperature includes selecting the second temperature to at least partially remove water from the sorbent while limiting desorption of carbon dioxide from the sorbent. A direct air capture system includes an adsorption system having at least one adsorption station and configured to receive a gas flow and a heating system arrangeable at the adsorption system, the heating system including at least one of a heater, the heater configured to heat gas flow to sorbent within the adsorption system, and a heat energy feature, the heat energy feature configured to provide heat energy to the sorbent.

### BACKGROUND

Removing carbon dioxide from ambient air for harvesting, sequestration or utilization is also known as direct air capture (DAC) and has become an active area of research by many for climate change mitigation. While there are various approaches for carbon dioxide removal from air, regenerable solid-sorbent systems have emerged as an attractive method, but some existing systems still exhibit poor performances.

DAC systems utilize adsorbent systems arranged to capture carbon dioxide via adsorption with sorbent. The sorbent is then delivered to a separate desorption system that typically employs heat in a sealed environment and often under vacuum to remove and collect the carbon dioxide from the sorbent.

Despite the many benefits and potential applications of DAC, the industry would be receptive to improvements in order to become more widely adopted.

### SUMMARY

A direct air capture process includes arranging sorbent to adsorb carbon dioxide and water from gas flow, the sorbent having a first temperature, and employing a heating system and heating the sorbent to a second temperature greater than the first temperature. Employing the heating system and heating the sorbent to the second temperature includes selecting the second temperature to at least partially remove water from the sorbent while limiting desorption of carbon dioxide from the sorbent.

A direct air capture system includes an adsorption system having at least one adsorption station and configured to receive a gas flow and a heating system arrangeable at the adsorption system, the heating system including at least one of a heater, the heater configured to heat gas flow to sorbent within the adsorption system, and a heat energy feature, the heat energy feature configured to provide heat energy to the sorbent; wherein the sorbent in the adsorption system is configured to adsorb carbon dioxide from the gas flow, the sorbent having a first temperature, the heating system configured to selectively heat the sorbent to a second temperature greater than the first temperature, the second temperature selected to desorb a first amount of water from the sorbent at the second temperature and minimize release of carbon dioxide from the sorbent at the second temperature.

### BRIEF DESCRIPTION OF THE DRAWINGS

The following descriptions should not be considered limiting in any way. With reference to the accompanying drawings, like elements are numbered alike:

FIG. 1 shows a flowchart of one embodiment of a process of direct air capture as disclosed herein;

FIG. 2 shows a flowchart of another embodiment of a process of direct air capture as disclosed herein;

FIG. 3 shows a flowchart of another embodiment of a process of direct air capture as disclosed herein;

FIG. 4 shows a flowchart of another embodiment of a process of direct air capture as disclosed herein;

FIG. 5 shows a perspective view of one embodiment of a heating system for the process of FIG. 1 as disclosed herein;

FIG. 6 shows a schematic view of one embodiment of a heater relative to multiple adsorption stations of sorbent in an adsorption system as disclosed herein;

FIG. 7 shows a top perspective view of one embodiment of a direct air capture system as disclosed herein;

FIG. 8 shows a schematic view of another embodiment of a heater relative to multiple adsorption stations of sorbent in an adsorption system as disclosed herein;

FIG. 9 shows a perspective view of another embodiment of multiple adsorption stations of sorbent in an adsorption stage relative to a heater as disclosed herein;

FIG. 10 shows a perspective view of another embodiment of multiple adsorption stations of sorbent in an adsorption stage relative to a heater as disclosed herein; and

FIG. 11 shows desorption data at first and second stages of desorption of water and CO2.

### DETAILED DESCRIPTION

A detailed description of one or more embodiments of the disclosed apparatus and method are presented herein by way of exemplification and not limitation with reference to the Figures.

Direct air capture (“DAC”) systems use a sorbent material that adsorbs CO2 from ambient air until saturated, at which point the sorbent must be regenerated. In addition to CO2, water vapor is also commonly adsorbed, and thus the water must be separated from the CO2 downstream of the DAC contactor. Because the volume of water captured can be as much as (if not more than) the volume of CO2 captured, there is significant energy duty requirement on the system to separate the water. The separation may be done via a condenser whereby the water condenses to liquid and the CO2 remains a gas, adding to the operational processes. The energy requirements for the separation stream are significant. Additionally, other components in the system may have to be oversized to manage the large volumes of water.

Disclosed herein, and in further detail below, are embodiments of a process and system which desorbs (regenerates) the sorbent in multiple stages. An initial stage or stages primarily desorbs a portion of the water such that the duty for separation is much lower (less volume, less energy). A latter stage or stages desorb any remaining water and the CO2. By desorbing portions of the adsorbed water at a time, less power is required to separate the water from the CO2 stream. Additionally, some components and equipment (such as, but not limited to, smaller condenser, chiller, vessels, valves, and pipelines) may be sized down since the volumes to process will be lower.

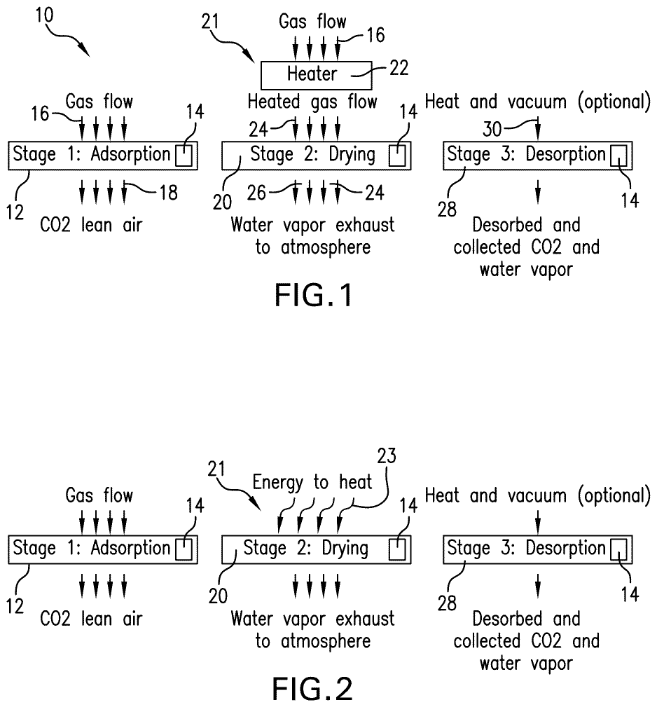

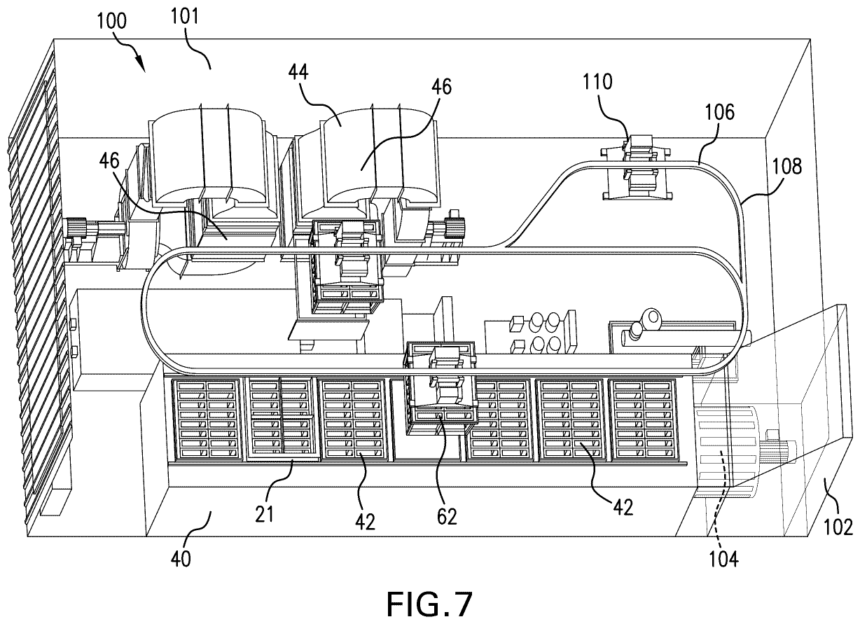

Referring to FIG. 1, an embodiment of a process 10 for a system 100 (FIG. 7), which is an airflow treatment system, more particularly an adsorption and desorption system or DAC system 101 (FIG. 7) is shown. The process 10 includes three stages. The first stage 12 is adsorption where a sorbent 14, captures CO2 from a gas flow 16, allowing CO2 lean air 18 to pass through. For a direct air capture system, the gas flow 16 is primarily or entirely air flow, so the term gas flow 16 is utilized herein to be inclusive of air flow and/or any other types of gas flow. The gas flow 16 may include water (H2O), and that water will be attracted by the sorbent 14 along with CO2, and the sorbent 14 can in some embodiments even collect more water vapor than CO2. The gas flow 16 may include ambient air and/or other gases and the gas flow 16 in the first stage 12 has a first temperature, typically the environmental temperature in which the DAC system is being utilized, and this first temperature permits the sorbent 14 to collect the CO2 as well as H2O.

When it is determined that the sorbent 14 is saturated with CO2 or is otherwise ready for further processing, then the sorbent 14 is treated with the second stage 20 of the process 10. The second stage 20 is a drying stage, where a heating system 21 is utilized for partial drying of the sorbent 14. In the embodiment of FIG. 1, the heating system 21 includes a heater 22 interposed between the sorbent 14 and the gas flow 16 such that the sorbent 14 is provided with heated gas flow 24, such as via convection heating, which at least partially dries the sorbent 14 and allows heated gas 24 and at least some water vapor 26 to pass through. In embodiments of the process 10, the heated gas flow 24 has a second temperature which is higher than the first temperature. The second temperature is sufficient to at least partially dry the sorbent 14 (releasing H2O therefrom), removing at least a first portion of water from the sorbent 14, but is insufficient to substantially desorb CO2. As shown in the illustrated embodiment of FIG. 1, the emitted gas from the sorbent 14 in the second stage 20 will be heated gas 24 and include water vapor 26. In some embodiments, a small amount of CO2 may be released during the second stage 20, although the temperature of the heated gas 24 can be adjusted to maximize the release of H2O while minimizing the release of CO2. The second temperature can be adjusted by adjusting the temperature of the heater 22. It should be understood that a temperature which desorbs CO2 will be dependent on the sorbent material utilized within the sorbent 14. In embodiments that will be further described below, the sorbent 14 is still positioned in an adsorption station for the second stage 20 of the process. In the second stage 20 there is some preliminary desorption of the water vapor, which can be simply removed from the sorbent 14 and exhausted to the atmosphere, as opposed to completing an entirety of water desorption in the main desorption process (third stage 28). Thus, at the second temperature, water may be removed from the sorbent 14 but not a substantial amount of CO2, because to substantially remove CO2 you must expose the sorbent 14 to a temperature higher than the second temperature. The heat utilized in process 10, particularly the second stage 20, may be supplied by an electrically resistive heater, or by a heat exchanger with indirect contact to a hot fluid such as steam. The inlet gas stream may be air or other pure or mixture of gases such as carbon dioxide or nitrogen.

The third stage 28 is desorption, where the at least partially dried sorbent 14 from the second stage 20 is positioned in a desorption station for application of heat 30 and optional vacuum for desorption and collection of the CO2 from the sorbent 14 and release of additional water vapor 26, a second portion of water, if water is still present in the sorbent 14. The heat 30 has a third temperature which is higher than the second temperature. The third temperature is sufficient to at least substantially desorb remaining CO2 from the sorbent 14. In one non-limiting example, the second temperature is sufficient to extract approximately 50% of water vapor contained in the sorbent 14 while releasing only approximately 10% of the collected CO2. The third temperature is then sufficient to desorb the remaining approximately 50% of water and 90% of CO2 from the sorbent 14. Thus, the process 10 beneficially removes at least a portion of water prior to the third stage 28 to reduce water in the system 100, efficiently ridding the sorbent 14 of water and collecting CO2.

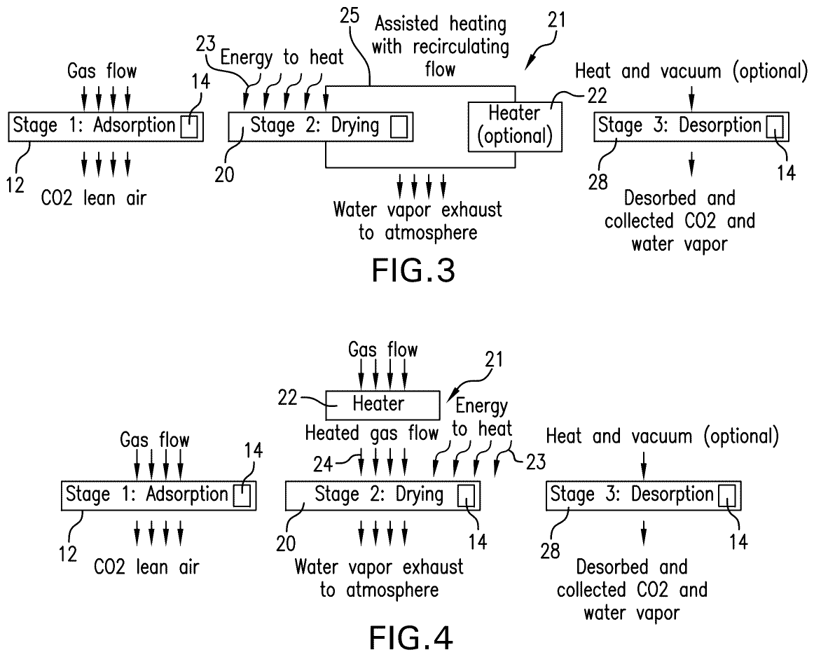

FIGS. 2-4 also include a first stage 12 of adsorption, a second stage 20 of drying, and a third stage 28 of desorption. As compared to FIG. 1, FIGS. 2-4 show alternative embodiments of heating the sorbent 14 within the second stage 20. Each embodiment of heating system 21 depicted in FIGS. 2-4 utilizes heat energy source or heat energy feature 23 to heat sorbent 14. The heat energy feature 23 may be electromagnetic, such as from, but not limited to, a microwave, induction, or radiation source, or conductive, such as, but not limited to, electrically resistive or heated fluid, or even a combination thereof. In some embodiments, the heat energy feature 23 can be applied by conduction (indirect steam), convection (direct steam), or electromagnetic (microwave, induction, or infrared radiation). In FIG. 2, the heating system 21 includes the heat energy feature 23 for the second stage 20 of drying but does not have flow passing through the dryer 22. In FIG. 3, the heating system 21 includes the heat energy feature 23, and is further assisted with recirculating flow 25. In one embodiment, the heater 22 may be additionally incorporated into the recirculating flow 25 of the heating system 21. In FIG. 4, the heating system 21 includes the heat energy feature 23 and is supplemented by the heater 22 which provides the heated gas flow 24 as previously described.

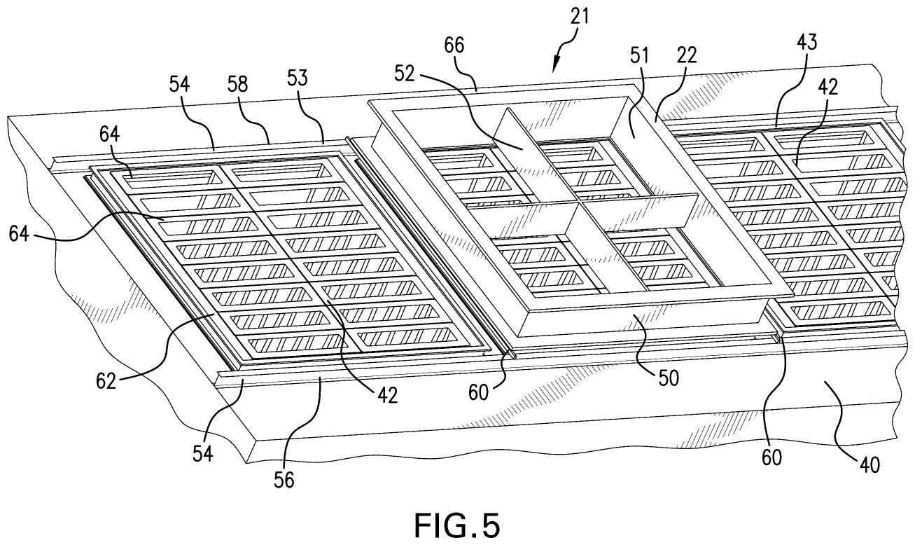

In each embodiment, the heating system 21, which may include the heater 22 and/or heat energy feature 23 as previously described, is not heating the sorbent 14 at the adsorption stage (first stage 12) and is therefore either off or inactive, or otherwise the heating system is simply not present or not in position at the adsorption station 42 (FIG. 5) that includes the sorbent 14. A fan or blower 104 (FIG. 7), downstream of the contactor or adsorption system 40, may be utilized to encourage flow therethrough.

In the second stage 20, the sorbent temperature is raised to the selected second stage temperature. In one embodiment, the selected second stage temperature is about 45 to about 60 degrees Celsius. The second stage temperature is selected to cause a significant portion of water (e.g. greater than 40%) to desorb from the sorbent 14, while a significant portion of CO2 (e.g. greater than 80%) remains bound to the sorbent 14. The water is evacuated and/or vacuumed to the exhaust stream.

In the third stage 28, heat is applied to raise sorbent temperature for full CO2 desorption. In one embodiment, the third stage temperature is about 100 degrees C. In some embodiments, the heat energy can be applied by conduction (indirect steam), convection (direct steam), or electromagnetic (microwave, induction, or infrared radiation). The third stage 28 may occur under vacuum.

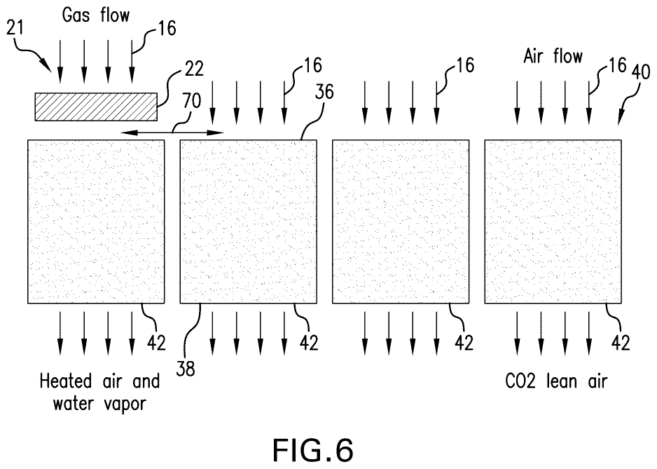

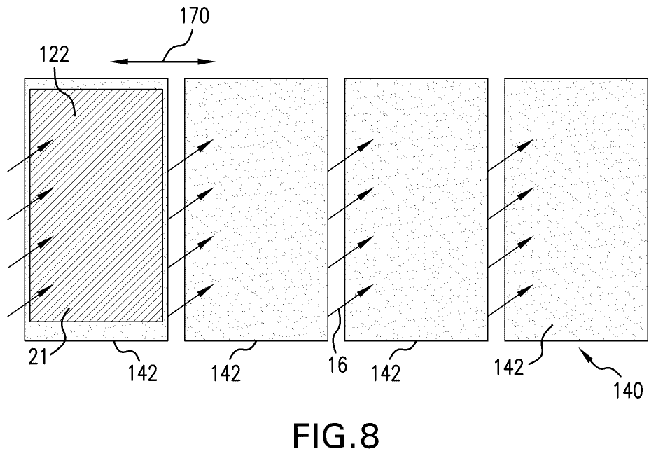

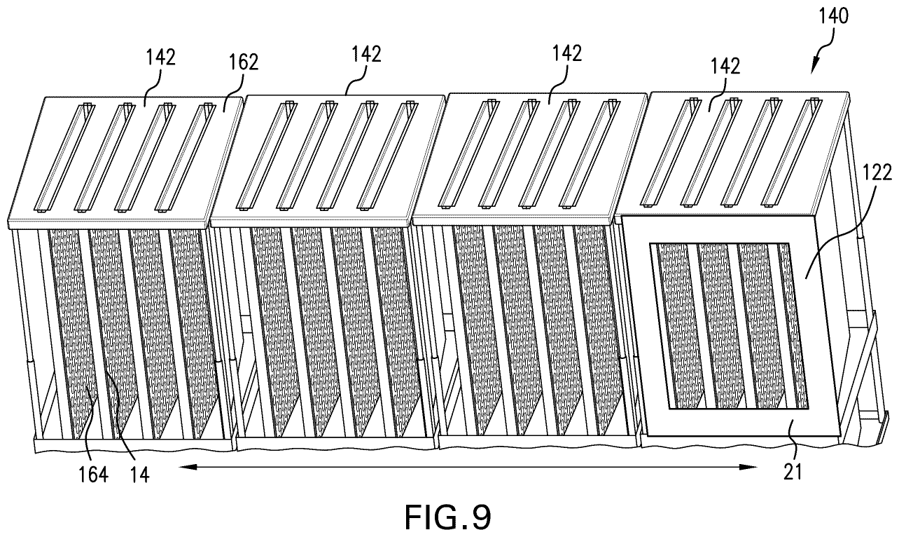

Turning now to FIG. 5, one embodiment of a heating system 21 is shown. The heating system 21 of FIG. 5 includes one or more heaters 22. The system 21 may include a single heater 22 or multiple heaters 22. The number of heaters 22 to adsorption stations 42 may be determined by the ratio of adsorption to drying process cycle times. The heater 22 is movably, such as slidably, positioned relative to a sub-system, such as an adsorption system 40, 140, the adsorption system 40, 140 having a plurality of adsorption stations 42, 142. While the phrase “adsorption system” is utilized here, it should be understood that the application of heat from the heater 22 will result in some partial desorption of at least water (see second stage 20 in FIGS. 1 to 4). CO2 and water adsorption occurs in the sorbents 14 contained within the adsorption systems 40, 140 prior to the application of heat from the heater 22. Therefore, as shown in FIG. 5, adsorption system 40 is a sub-system of the system 100 that is used in both a first stage and a second stage of the process 10. Further, while the heater 22 is described as movable with respect to the adsorption station 42, alternate embodiments may include the adsorption station 42 and/or sorbent 14 being movable with respect to the heater 22. In the illustrated embodiment of FIG. 5, the heater 22 is sized to at least substantially encircle a periphery of the opening to adsorption station 42, although could also be positioned relative to adsorption station 142 (FIGS. 8-9). In some embodiments, the heater 22 may be oriented for predominately vertical gas flow as illustrated in FIG. 6, and in some embodiments the heater may be oriented for predominately horizontal gas flow as shown in FIGS. 8-9. It should be understood that not all gas flow will be directly vertical in the embodiment shown in FIG. 6, but that the adsorption stations 42 are configured to mainly receive gas flow from a vertical (top) entry point rather than a horizontal (front/side) entry point. Likewise, not all gas flow will be directly horizontal in the embodiment shown in FIGS. 8-9, but the adsorption stations 142 are designed to mainly receive gas flow from a horizontal (front/side) entry point rather than a vertical (top) entry point. While the illustrated embodiment illustrates the heater 22 positioned on the adsorption system 40, it should be understood that the heater 22 and/or alternative heat energy feature 23 as described with respect to FIGS. 1-4 may also be positioned on the adsorption system 40, 140 as well as other adsorption configurations known in the art.

Referring again to FIG. 5, the illustrated heater 22 may include a frame 50 and any necessary support beams 52 within the frame 50. In some embodiments, the heater 22 includes an opening 51 in the frame 50 that permits gas flow into the adsorption station 42 upon which it is seated. The support beams 52 cross the opening 51, but do not substantially block gas flow into the adsorption station 42. In some embodiments, the opening 51 is approximately the same size as a gas flow opening 43 to the adsorption station 42. In the illustrated embodiment, the gas flow 16 passes through the opening 51 to become heated gas flow 24. In one embodiment, the heater 22 is an electrically resistive heater, although other types of heaters are also within the scope of these embodiments. To move the heater 22 from one adsorption station to another adsorption station, e.g. from one adsorption station 42 to another adsorption station 42 as depicted in FIG. 4, the adsorption system, e.g. the adsorption system 40 as depicted in FIG. 5, may include a heater positioning system 53 that is also part of the heating system 21. In one embodiment, the heater positioning system 53 includes one or more rails 54. More particularly, a first rail 56 may be positioned along a first side of the adsorption stations 42 and a second rail 58 may be positioned along an opposing second side of the adsorption stations 42 such that a pair of rails 56, 58 may span a length of the adsorption system 40. The heater 22 may be designed to slide directly on the rails 56, 58, or may rest upon cross bars 60 that rest on and are slidably engaged with the rails 56, 58. In such an embodiment, the heater positioning system 53 enables selective slidable movement of the heater 22 with respect to the adsorption stations 42 in the adsorption system 40, where the rail or rails 56, 58 are configured to be stationary with respect to the adsorption system 40, and the heater 22 (or heaters 22) is slidably seated on the rail or rails 56, 58.

Other connective arrangements of the heater positioning system 53 including but not limited to wheels, tongue and groove engagements, and magnetics may be employed to enable sliding the heater 22 from one adsorption station 42 to another adsorption station 42. For example, the adsorption system 40 may include grooves and the heater 22 may include projections such as pins that slide within the grooves. Such an embodiment may be useful for adsorption stations that are positioned in rows and/or columns within an adsorption system so that the heater 22 may change “direction” and be moved to a different row or column of adsorption stations. Alternatively, the heater positioning system 53 may slidably connect the heater 22 to a rack that is positioned over the adsorption system 40 (or to the side of the adsorption system 140 for the embodiment shown in FIG. 8-9) but not directly on the adsorption system 40.

The heating system 21 may further include any required power and control system 66 that includes the necessary features and control logic to power and operate the heater 22 and the heater positioning system 53. The power and control system 66 may include, but is not limited to, an electrical source, a motor, and a computer which may be used to control the motor and thus movement of the heater 22 as well as operation of any heating elements within the heater 22. The computer of the power and control system 66 may further receive any sensed data sent thereto by the adsorption system 40 which may be used for determining the operations of the heating system 21, such as, but not limited to, selected movement of the heater 22 and temperature of the heater 22.

Although the process 10 is not limited to a particular sorbent 14, the sorbent 14 may be, for example, metal-organic frameworks (“MOFs”), Zeolites, amine-impregnated porous materials, amine-functionalized porous materials, or a combination of one or more of the above. The sorbent 14 may also be another sorbent known in the art or a combination of sorbents including those known in the art. The sorbent 14 may be arranged within a sorbent cart or sorbent container 62 for each adsorption station 42, where the sorbent container 62 or contactor may be moved in and out of the adsorption station 42 as needed, such as when the sorbent 14 is to be moved from the adsorption system 40 to a desorption system 44 (FIG. 6). Each sorbent container 62 may contain one or more sorbent modules 64 as shown in FIG. 4. Each sorbent module 64 is exposed to gas flow 16 or, when the heater 22 is disposed thereon, heated gas flow 24.

FIG. 6 depicts a diagrammatic side view of one embodiment of the adsorption system 40 where one or more individual adsorption stations 42 are located. While four adsorption stations 42 are depicted, it would be within the scope of these embodiments for the adsorption system 40 to include any number of adsorption stations 42. Each adsorption station 42 holds sorbent 14 (FIG. 1). The sorbent 14 may take any known form or arrangement, such as, but not limited to, one or more sorbent units, containers, and/or cartridges or one or more monoliths of sorbent. Unless intentionally blocked, such as by a door, each adsorption station 42 can be exposed to gas flow 16 at an inlet 36 thereof. The adsorption system 40 further includes the heater 22 that is movable as indicated by directions 70 at the inlet 36 of the adsorption stations 42. In the illustrated embodiment, the heating system 21 does not include a heater 22 at an outlet 38 of the adsorption stations 42, where as illustrated in FIG. 6, the inlet 36 is on an opposite side of the adsorption stations 42, with respect to gas flow therethrough, from the outlet 38. This arrangement of the heater 22 with respect to the adsorption stations 42 allows heated gas and water vapor to pass through the adsorption stations 42.

When an adsorption station 42 is in need of drying, as in the second stage 20 of the process 10 as described with respect to FIGS. 1 to 4, the heater 22 (and/or other heat energy feature 23) is positioned adjacent the selected adsorption station 42 to heat the gas flow 16, in the case of using the heater 22, into the adsorption station 42 such that the sorbent 14 within the selected adsorption station 42 is heated and heated gas 24 and water vapor 26 exit the adsorption station 42. The heater 22 is shareable by multiple adsorption stations 42, and positionable at the adsorption system 40 to service any of the multiple adsorption stations 42 therein. In one embodiment, the heater 22 is positionable at a single adsorption station 42 at a time, while the remaining adsorption stations 42 are exposed to unheated gas flow 16. The heater 22 is then movable in one of the directions 70 to other adsorption stations 42 when the sorbent 14 is sufficiently dried in the second stage 20. In some embodiments, the heater 22 may be sized to cover more than one adsorption station 42 at a time while a remainder of the adsorption stations 42 are in receipt of the unheated gas flow 16. In still other embodiments, such as embodiments with a large amount of adsorption stations 42, more than one heater 22 may be employed, where each heater 22 is positionable to cover one or more adsorption stations 42 at a time. The moveable heater 22 in embodiments described herein is shareable between adsorption stations 42, but not all of the adsorption stations 42 can be dried at the same time using the heater 22.

The heater 22 is movable between the gas flow 16 and the adsorption stations 42. In the embodiment shown in FIG. 6, the heater 22 is slidable from one adsorption station 42 to another adsorption station 42 within the adsorption system 40. In one embodiment, the heater 22 is slidable from one adsorption station 42 to an adjacent adsorption station 42, although in some embodiments the heater 22 need not stop at an adjacent adsorption station 42 and may instead be positioned to an adsorption station 42 in greater need of drying. Further, in some embodiments, the sorbent 14, whether within the sorbent modules 64 in sorbent cart or sorbent container 62 or other movable contactor, may be moved relative to the heater 22, and/or both the sorbent 14 and the heater 22 may be moved relative to each other. In other embodiments, there may be multiple stationary heaters 22 at each adsorption station 42 that turn on and off depending on the process stage. Further, while the heater 22 is depicted, the heating system 21 may additionally or alternatively include the heat energy feature 23 with or without recirculating flow 25. Further, any subset or elements of the heating system 21 including but not limited to the heater 22, heat energy feature 23, and recirculating flow 25 may be either fixed or movable with respect to the adsorbent stations 42.

FIG. 7 shows one embodiment of an adsorption and desorption system or DAC system 101. The DAC system 101 includes adsorption system 40 (sub-system for first and second stages of process 10) and desorption system 44 (sub-system for third stage of process 10), as well as the heating system 21 (for second stage of process 10). The adsorption system 40 may include a gas outlet 102. A blower 104 may be disposed upstream of the gas outlet 102 to generate and/or increase flow of the gas. The blower 104 is arranged to pull in atmospheric air or and/or other gas, the gas flow 16, through one side of the sorbent container 62, and if the heater 22 (and/or other heat energy feature 23) is disposed in between the sorbent container 62 and the gas flow 16, then the gas flow into the sorbent container 62 will be heated by the heater 22. The gas flow is exhausted in a single pass gas flow or a heated single pass gas flow. The blower 104 may be disposed at other locations within the adsorption system 40 for generating and/or increasing flow of the gas.

As previously described, the adsorption system 40 may include adsorption stations 42. The desorption system 44 may include one or more desorption stations 46. In some embodiments, there may be more adsorption stations 42 than desorption stations 46 when the desorbing process (third stage 28) takes less time than the adsorbing process (first stage 12). Also, due to the additional drying stage (second stage 20), the desorbing process (third stage 28) may take even less time, thus requiring less desorption stations 46.

The DAC system 101 may further include a transport system 106 operable to move the sorbent containers 62 to and from adsorption stations 42 and desorption stations 46. While the transport system 106 may take many forms, the illustrated embodiment of the transport system 106 includes a rail 108 on which sorbent cart carriers 110 are disposed. While FIG. 7 shows three sorbent cart carriers 110, any number of sorbent cart carriers 110 may be disposed on the rail 108. Further, the rail 108 is not limited to any specific shape. The rail 108 may be shaped to have portions thereof align with each of the adsorption stations 42 and desorption stations 46. The rail 108 may be either stationary, with motorized rail engagement portions mounted on the sorbent cart carriers 110 to move the sorbent cart carriers 110 relative to the rail 108, or the rail 108 may be movable with the sorbent cart carriers 110 attached, such as, but not limited to, clamped, to the rail 108 so that the sorbent cart carriers 110 move with the rail 108. The sorbent cart carriers 110 may include engagement structures to selectively engage with the sorbent containers 62 for moving the sorbent containers 62 between an adsorption station 42 and a desorption station 46.

The transport system 106 and the heating system 21 may be automated such that movement of the sorbent containers 62 to and from the adsorption and desorption stations 40, 46 and movement of the heater 22 to selected adsorption stations 42 occurs when the sorbent modules 64 are ready for the next stage of the process 10. As previously described, the heating system 21 includes heater 22, which may be movable relative to the adsorption stations 42 to heat the gas flow to a selected adsorbing station 42, located at the adsorption system 40, and therefore a drying station separate from the adsorption system 40 and desorption system 44 is not required in the DAC system 101 to remove a portion of water prior to the third stage desorption process. Further, the heater 22 does not interfere with movement of sorbent 14 in sorbent container 62 from the adsorption system 40 to the desorption system 44 because the heater 22 can simply be positioned to a different adsorption station 42. Alternatively, in some embodiments, the heater 22 may be positioned to a “home” station where there is no adsorption station 42. The rails 54, or other heater positioning system 53, may also be located on or relative to the adsorption system 40 so as not to block the ingress or egress of a sorbent container 62 into the adsorption system 40. While one particular embodiment has been described, it should be understood that any type of transport system and/or carrier may be utilized to move sorbent 14 within system 100.

With reference to FIGS. 8 and 9, an alternate embodiment of an adsorption system 140 is shown. The adsorption system 140 includes adsorption stations 142 and, in this embodiment the heating system 21 includes a heater 122, depicted diagrammatically, movable in directions 170 with respect to a side (such as a front side) of the adsorption stations 142 to selectively heat the gas flowing through a selected adsorption station 142. In some embodiments, the heater 122 is oriented for predominately horizontal gas flow as illustrated. It should be understood that not all gas flow will be directly horizontal, but that the adsorption station 142 is designed to mainly receive gas flow from a horizontal (side/front) entry point rather than a vertical (top) entry point. In some embodiments, the heater 122 may include the frame 50 and other features of the heater 22 as shown in FIG. 5, for permitting gas flow 16 to pass through the heater 122 and exit the opposing side of the adsorption station 142, although the heater 122 may have other shapes. As the second stage 20 is for drying and not CO2 collection, the heater 122 is not sealed to the adsorption stations 142, and the heater need only be positioned on one side of the adsorption stations 142, with no movable parts required on an opposing side. The heating system 21 in the embodiments shown in FIGS. 8 and 9 may further include a heater positioning system 53 and power and control system 66 such as shown in FIG. 5 for selectively positioning, such as sliding, the heater 122 into place adjacent a selected adsorption station 142 for drying. The sorbent 14 may be disposed within sorbent modules 164 held in sorbent containers 162 in the adsorption stations 142.

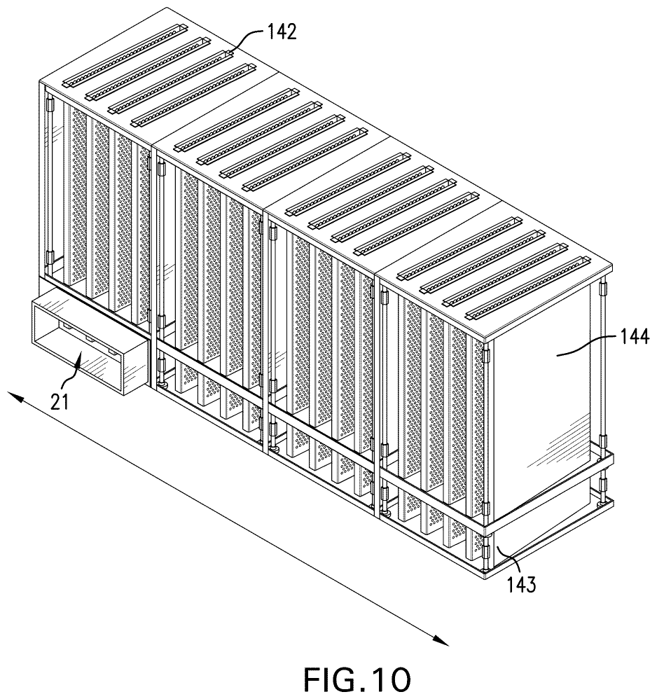

As previously noted, the process 10 may incorporate a variety of sorbents 14 and sorbent modules 64, and therefore FIG. 9 depicts another example usable within a DAC system 101. In FIG. 9, sorbent pellets are used in the sorbent container 162, and the sorbent containers 162 are arranged in batches. In the illustrated embodiment, four sorbent containers 162 are shown in a batch, and the entire batch may be delivered to a desorption system after the drying stage is completed. FIG. 10 illustrates the heating system 21 positionable at a drying section 143 located at a bottom of an adsorption section 144 of the adsorption station 142. The pellets of sorbent 14 move by gravity from the adsorption section 144 where the adsorption stage, first stage 12, occurs into the drying section 143 for the water drying stage, second stage 20. The pellets of the sorbent 14 may be moved in batches or may be continuously moved at a rate that enables exposure time to the heat for the drying stage, second stage 20. In some embodiments, the heating system 21 includes a single heater 22 that moves laterally as depicted, although a plurality of heaters 22 may be incorporated, or alternatively a stationary heater 22 may be provided at each drying section 143 which may be selectively controlled to heat the sorbent 14. The heating system 21 may alternatively or additionally include the heat energy feature 23 as described in the embodiments depicted in FIGS. 1-4.

The intermediate drying stage, second stage 20, according to embodiments of this invention occurs at the individual adsorption stations 42, 142, as opposed to removing the sorbent 14 from the adsorption stations 42, 142 and delivering the sorbent 14 to another separate drying station, such as a separate chamber that is specific to drying. In the FIG. 10 embodiment, the sorbent 14 is merely moved by gravity to the drying section 143 which does not increase the footprint of the adsorption station 142. Thus, the second stage 20 reduces the space required for the system 100, providing it with a smaller footprint, as well as reduces the delivery requirements and cycle time associated with having to move the sorbent 14 to a separate drying station. The movable heater 22, 122 also reduces the need and expense of providing a heater at every adsorption station, although other stationary heaters and heating sources may be used that can be turned on and off when needed. The second stage 20 also advantageously reduces the residency time the sorbent 14 needs to spend in the third stage 28 by reducing the work required of the desorption stations 46 as opposed to a process that must remove all the water in a desorption station. This also allows the desorption stations 46 to be smaller and/or fewer in the third stage 28 than would otherwise be required in a system that must remove all of the water in a desorption stage.

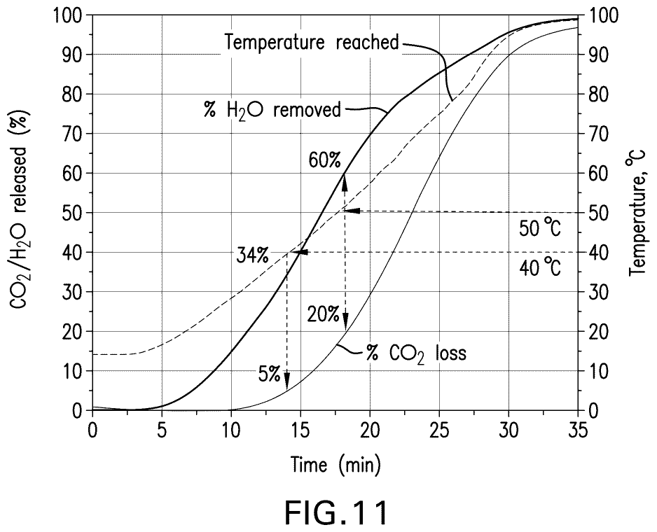

FIG. 11 shows a graph of a pipe rig laboratory desorption test temperature ramp using air flow. The graph of desorption data is under N2 flow, where the H2O and CO2 release at different amounts and temperature increases. Water is desorbed at lower temperatures than the CO2, enabling a drying process at lower temperature without significant CO2 loss.

In the above-described embodiments, multi-stage processes and systems are provided where a portion of water is desorbed from sorbent in an initial stage or stages by utilizing a first temperature that desorbs a first portion of water and a following stage utilizes a second temperature higher than the first temperature to desorb the CO2 and any remaining water.

The direct air capture system has been described wherein the sorbent not heated by the heater is at a first temperature, the heater and/or heat energy feature configured to heat the sorbent to a second temperature greater than the first temperature to remove at least some water contained in the sorbent, and further comprising a desorption system, the desorption system configured to remove carbon dioxide contained in the sorbent at a third temperature greater than the second temperature, wherein the second temperature removes a first portion of the water from the sorbent and the third temperature removes a second portion of the water from the sorbent.

Set forth below are some embodiments of the foregoing disclosure:

Embodiment 1. A direct air capture process includes arranging sorbent to adsorb carbon dioxide and water from gas flow, the sorbent having a first temperature, and employing a heating system and heating the sorbent to a second temperature greater than the first temperature wherein employing the heating system and heating the sorbent to the second temperature includes selecting the second temperature to at least partially remove water from the sorbent while limiting desorption of carbon dioxide from the sorbent.

Embodiment 2. The direct air capture process of any prior embodiment wherein the heating system includes at least one of a heater, the heater configured to heat gas flow to the sorbent, and a heat energy feature, the heat energy feature configured to provide heat energy to the sorbent.

Embodiment 3. The direct air capture process of any prior embodiment wherein the heating system includes one or more of the heater.

Embodiment 4. The direct air capture process of any prior embodiment wherein employing the heating system includes moving at least one of the heater and the sorbent.

Embodiment 5. The direct air capture process of any prior embodiment wherein moving at least one of the heater and the sorbent includes sliding the heater to a selected adsorption station containing the sorbent amongst a plurality of adsorption stations within an adsorption system.

Embodiment 6. The direct air capture process of any prior embodiment wherein the heater includes a frame arranged to heat the gas flow passing through an opening in the frame to the sorbent.

Embodiment 7. The direct air capture process of any prior embodiment wherein the heating system includes the heat energy feature.

Embodiment 8. The direct air capture process of any prior embodiment further comprising assisting the heating system with recirculating flow and/or including the heater.

Embodiment 9. The direct air capture process of any prior embodiment wherein arranging sorbent includes positioning the sorbent in an adsorption station of an adsorption system, the adsorption station having an adsorption section to adsorb carbon dioxide and water from the gas flow, and a drying section, the sorbent movable by gravity from the adsorbent section to the drying section, and employing the heating system includes moving at least one of a heater and a heat energy source relative to the drying section.

Embodiment 10. The direct air capture process of any prior embodiment wherein the second temperature is less than 100 degrees Celsius.

Embodiment 11. The direct air capture process of any prior embodiment wherein the second temperature is between approximately 40 degrees and approximately 60 degrees.

Embodiment 12. The direct air capture process of any prior embodiment wherein heating the sorbent to the second temperature desorbs at least approximately 40% of the water from the sorbent and less than approximately 20% of carbon dioxide from the sorbent.

Embodiment 13. The direct air capture process of any prior embodiment further comprising, subsequent employing the heating system, increasing the temperature of the sorbent to a third temperature greater than the second temperature and removing substantially all remaining water and carbon dioxide from the sorbent.

Embodiment 14. The direct air capture process of any prior embodiment subsequent employing the heating system and prior to increasing the temperature of the sorbent to the third temperature, moving the sorbent from an adsorption system to a desorption system.

Embodiment 15. A direct air capture system includes an adsorption system having at least one adsorption station and configured to receive a gas flow, and a heating system arrangeable at the adsorption system, the heating system including at least one of a heater, the heater configured to heat gas flow to sorbent within the adsorption system, and a heat energy feature, the heat energy feature configured to provide heat energy to the sorbent, wherein the sorbent in the adsorption system is configured to adsorb carbon dioxide from the gas flow, the sorbent having a first temperature, the heating system configured to selectively heat the sorbent to a second temperature greater than the first temperature, the second temperature selected to desorb a first amount of water from the sorbent at the second temperature and minimize release of carbon dioxide from the sorbent at the second temperature.

Embodiment 16. The direct air capture system of any prior embodiment wherein the heating system includes the heat energy feature, and further including heating assistance with recirculating flow.

Embodiment 17. The direct air capture system of any prior embodiment wherein the heating system includes the heater, a heater positioning system enabling respective movement of the heater and the sorbent, and the heating system includes one or more of the heater.

Embodiment 18. The direct air capture system of any prior embodiment wherein the heating system includes the heater, the heater including a frame that heats the gas flow that passes through an opening in the frame to the sorbent, and the heating system includes one or more of the heater.

Embodiment 19. The direct air capture system of any prior embodiment wherein the heater heats the gas flow passing into an inlet of a selected adsorption station within the adsorption system, and heated gas flow and water pass through an outlet of the selected adsorption station.

Embodiment 20. The direct air capture system of any prior embodiment wherein the adsorption station includes an adsorption section and a drying section, and the heating system includes the heater positionable at the drying section of the adsorption station, and the adsorption station is configured to selectively permit the sorbent to fall by gravity from the adsorption section of the adsorption station to the drying section.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A direct air capture process comprising:
arranging sorbent to adsorb carbon dioxide and water from gas flow, the sorbent having a first temperature; and
employing a heating system and heating the sorbent to a second temperature greater than the first temperature;
wherein employing the heating system and heating the sorbent to the second temperature includes selecting the second temperature to at least partially remove water from the sorbent while limiting desorption of carbon dioxide from the sorbent.

2. The process of claim 1, wherein the heating system includes at least one of a heater, the heater configured to heat gas flow to the sorbent, and a heat energy feature, the heat energy feature configured to provide heat energy to the sorbent.

3. The process of claim 2, wherein the heating system includes one or more of the heater.

4. The process of claim 3, wherein employing the heating system includes moving at least one of the heater and the sorbent.

5. The process of claim 4 wherein moving at least one of the heater and the sorbent includes sliding the heater to a selected adsorption station containing the sorbent amongst a plurality of adsorption stations within an adsorption system.

6. The process of claim 3, wherein the heater includes a frame arranged to heat the gas flow passing through an opening in the frame to the sorbent.

7. The process of claim 2, wherein the heating system includes the heat energy feature.

8. The process of claim 7, further comprising assisting the heating system with recirculating flow and/or including the heater.

9. The process of claim 1, wherein arranging sorbent includes positioning the sorbent in an adsorption station of an adsorption system, the adsorption station having an adsorption section to adsorb carbon dioxide and water from the gas flow, and a drying section, the sorbent movable by gravity from the adsorbent section to the drying section, and employing the heating system includes moving at least one of a heater and a heat energy source relative to the drying section.

10. The process of claim 1, wherein the second temperature is less than 100 degrees Celsius.

11. The process of claim 10, wherein the second temperature is between approximately 40 degrees and approximately 60 degrees.

12. The process of claim 1, wherein heating the sorbent to the second temperature desorbs at least approximately 40% of the water from the sorbent and less than approximately 20% of carbon dioxide from the sorbent.

13. The process of claim 1 further comprising, subsequent employing the heating system, increasing the temperature of the sorbent to a third temperature greater than the second temperature and removing substantially all remaining water and carbon dioxide from the sorbent.

14. The process of claim 13, subsequent employing the heating system and prior to increasing the temperature of the sorbent to the third temperature, moving the sorbent from an adsorption system to a desorption system.

15. A direct air capture system comprising:
an adsorption system having at least one adsorption station and configured to receive a gas flow; and
a heating system arrangeable at the adsorption system, the heating system including at least one of a heater, the heater configured to heat gas flow to sorbent within the adsorption system, and a heat energy feature, the heat energy feature configured to provide heat energy to the sorbent;
wherein the sorbent in the adsorption system is configured to adsorb carbon dioxide from the gas flow, the sorbent having a first temperature, the heating system configured to selectively heat the sorbent to a second temperature greater than the first temperature, the second temperature selected to desorb a first amount of water from the sorbent at the second temperature and minimize release of carbon dioxide from the sorbent at the second temperature.

16. The direct air capture system of claim 15, wherein the heating system includes the heat energy feature, and further including heating assistance with recirculating flow.

17. The direct air capture system of claim 15, wherein the heating system includes the heater, a heater positioning system enabling respective movement of the heater and the sorbent, and the heating system includes one or more of the heater.

18. The direct air capture system of claim 15, wherein the heating system includes the heater, the heater including a frame that heats the gas flow that passes through an opening in the frame to the sorbent, and the heating system includes one or more of the heater.

19. The direct air capture system of claim 18, wherein the heater heats the gas flow passing into an inlet of a selected adsorption station within the adsorption system, and heated gas flow and water pass through an outlet of the selected adsorption station.

20. The direct air capture system of claim 15, wherein the adsorption station includes an adsorption section and a drying section, and the heating system includes the heater positionable at the drying section of the adsorption station, and the adsorption station is configured to selectively permit the sorbent to fall by gravity from the adsorption section of the adsorption station to the drying section.
